(19) United States
(12) Patent Application Publication
(10) Pub. No.: US 2015/0168953 A1
(43) Pub. Date: Jun. 18, 2015

(54) AUTONOMOUS SELF-LEVELING VEHICLE

(71) Applicant: iTrack LLC, Rochester, MI (US)

(72) Inventor: Edzko Smid, Oakland Township, MI (US)

(21) Appl. No.: 14/570,572

(22) Filed: Dec. 15, 2014

Related U.S. Application Data
(60) Provisional application No. 61/915,669, filed on Dec. 13, 2013.

(51) Int. Cl. G05D 1/02; G01S 5/14

(52) U.S. Cl. CPC G05D 1/0246; G05D 1/0278; G05D 1/028; G01S 5/14

(57) ABSTRACT

An autonomous self-leveling vehicle is provided that includes a controller and an RF antenna. A platform is attached to articulating legs with joint actuators for leveling or maintaining said platform at a defined angle. A set of wheels are powered by wheel actuators mounted to the distal ends of the articulating legs to provide self-leveling. A system for a self-leveling vehicle includes at least three or more base stations. A vehicle with a platform having articulating legs with joint actuators for leveling or maintaining the platform at a defined angle is provided above and operates with an RF antenna mounted to the vehicle and a controller with a tracking module in the range of the base stations.

### RELATED APPLICATIONS

This application claims priority benefit of U.S. Provisional Application Ser. No. 61/915,669 filed 13 Dec. 2013; the contents of which are hereby incorporated by reference.

### FIELD OF THE INVENTION

The present invention in general relates to remote controlled vehicles, and in particular to a vehicle that combines autonomous vehicle control, with independent azimuth and elevation control for a position sensitive application payload

### BACKGROUND OF THE INVENTION

The Global Positioning System (GPS) is based on the fixed location base stations and the measurement of time-of-flight of accurately synchronized station signature transmissions. The base stations for the GPS are satellites and require atomic clocks for synchronization.

GPS has several draw backs including relatively weak signals that do not penetrate heavy ground cover and/or man made structures. Furthermore, the weak signals require a sensitive receiver. GPS also utilizes a single or narrow band of frequencies that are relatively easy to block or otherwise jam, and can easily reflect to surfaces, resulting in multi-path errors. The accuracy of the GPS system relies heavily on the use of atomic clocks, which are expensive to make and operate.

U.S. Pat. No. 7,403,783 entitled “Navigation System,” herein incorporated in its entirety by reference, improves the responsiveness and robustness of location tracking provided by GPS triangulation, by determining the location of a target unit (TU) in terrestrial ad hoc, and mobile networks. The method disclosed in U.S. Pat. No. 7,403,783 includes initializing a network of at least three base stations (BS) to determine their relative location to each other in a coordinate system. The target then measures the time of difference arrival of at least one signal from each of three base stations. From the time difference of arrival of signals from the base stations, the location of the target on the coordinate system can be calculated directly. Furthermore, the use of high frequency ultra-wide bandwidth (UWB) wireless signals provide for a more robust location measurement that penetrates through objects including buildings, ground cover, weather elements, etc., more readily than other narrower bandwidth signals such as the GPS. This makes UWB advantageous for non-line-of-sights measurements, and less susceptible to multipath and canopy problems.

Controller area network (CAN) is a vehicle bus standard designed to allow microcontrollers and devices to communicate with each other within a vehicle without a host computer. CAN bus is a message-based protocol, designed specifically for automotive applications but now also used in other areas such as industrial automation and medical equipment.

A critical component to autonomously guide a vehicle that requires evenness or a steady position for a payload to operate properly is to create a path that the vehicle can traverse. When a human-operated vehicle moves near unevenness (bump or hole) in the path, the operator may control the vehicle around that area, to maintain a smooth ride for the vehicle platform. While, a lot of work has been done on path-planning, obstacle avoidance, and terrain recognition, these technologies are expensive and not always robust.

Thus, there exists a need for an integrated system that combines autonomous vehicle control, with independent azimuth and elevation control for an application payload that is reliable and cost effective.

### SUMMARY OF THE INVENTION

An autonomous self-leveling vehicle is provided that includes a controller and an RF antenna. A platform is attached to articulating legs with joint actuators for leveling or maintaining said platform at a defined angle. A set of wheels are powered by wheel actuators mounted to the distal ends of the articulating legs to provide self-leveling.

A system for a self-leveling vehicle includes at least three or more base stations. A vehicle with a platform having articulating legs with joint actuators for leveling or maintaining the platform at a defined angle is provided above and operates with an RF antenna mounted to the vehicle and a controller with a tracking module in the range of the base stations.

### BRIEF DESCRIPTION OF THE DRAWINGS

FIG. 1A is a side view of an embodiment of the inventive autonomous self-leveling vehicle;

FIG. 1B. is a top view of the inventive autonomous self-leveling vehicle of FIG. 1;

FIG. 2 is a schematic diagram of the electronic components that form a tilt-compensated (TC) compass to determine vehicle position and orientation; and

FIG. 3 is a schematic representation of a location measurement device illustrating roll, pitch and yaw measurement determined from 3D accelerometers and 3D magnetic sensors.

### DETAILED DESCRIPTION OF THE INVENTION

An inventive autonomous self-leveling vehicle provides a drive-by-wire vehicle with an adjusting self-leveling platform. The drive-by-wire system used in embodiments of the autonomous self-leveling vehicle use joint actuators to control the attitude of the vehicle platform via articulated legs attached to the platform and wheels, and wheel drive actuators to perform steering and driving for the vehicle, to provide control and movement in an operating space. In an embodiment, a communication interface for the drive-by-wire components may be controller area network (CAN), or other available controller based communication technologies. Embodiments of the autonomous self-leveling vehicle have a vehicle controller that communicates with an operator, and includes a position tracking system. The position tracking system could be standard GPS or the tracking system described in the aforementioned U.S. Pat. No. 7,403,783, or other radio frequency (RF) based position tracking systems. The vehicle controller communicates with the drive-by-wire vehicle actuators to control the vehicle motion and attitude during autonomous operation. Embodiments of the inventive vehicle have an autonomous navigation module that includes antenna, 3D accelerometer, 3D compass, 3D gyroscopic sensors, and a microcontroller with software. A non-limiting application of an embodiment of an autonomous self-leveling vehicle is in the entertainment industry, for maneuvering still and movie cameras during scenes or sequences.

In embodiments of the inventive vehicle, the leveling a platform is oriented relative to earth's plane of gravity. A non-limiting example of a self-leveling method is described in U.S. Pat. No. 7,908,041 entitled “Self-Leveling Laser Horizon for Navigation Guidance,” herein incorporated in its entirety by reference. Embodiments of the invention combine autonomous vehicle control, with independent azimuth and elevation control for the application payload.

In embodiments of the vehicle, integration of the operational system (platform leveling method with the autonomous guidance) is accomplished by first implementing the vehicle guidance software and the platform leveling software in the same architecture, and sharing inertial sensor inputs. Furthermore, the system may require extra user input, to understand the objective of the operating scenario or picture or movie shoot. For example, path planning and programming should include combined X/Y location, and orientations, so the autonomous vehicle controller “knows” how the user would like the payload to move though space or to shoot the scene. Furthermore, integration of the leveling algorithms with the autonomous vehicle control system, is of benefit since the leveling algorithms can be programmed to anticipate vehicle motion, and in particular when turning the vehicle on an inclined surface, where anticipation helps to maintain leveling performance of the platform by predicting the simultaneous roll/pitch motion during an inclined yaw maneuver.

Furthermore through integration of the platform leveling method with the autonomous guidance, the autonomous control system of the vehicle controller can be programmed to maneuver the vehicle along a desired path in a way that benefits the platform leveling system. For example, when driving on an incline, the controller may have the liberty to drive forward or reverse (and even more freedom of maneuverability with omni-directional vehicles) in order to orientate the vehicle so to optimize leveling of the chassis.

In an embodiment, a separate azimuth/elevation drive can be attached to the vehicle chassis to provide independent camera motion relative to the platform. However, if the camera motion system has mechanical limitations, these could be compensated by the vehicle autonomous control and leveling. For example the chassis leveling system could maintain the platform at a constant desired non-zero angle, to provide additional elevation angle.

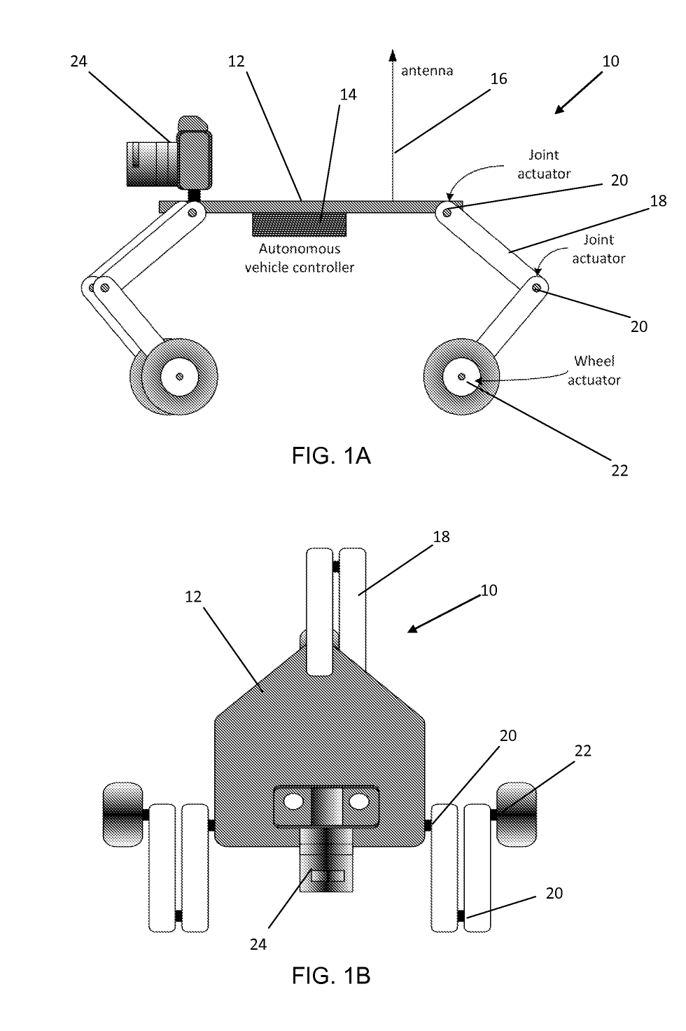

FIGS. 1A and 1B illustrate an embodiment of a self-leveling autonomous vehicle 10 being used as a motion platform in the entertainment industry for automated still and motion camera control. The vehicle 10 has a platform 12 for mounting a camera 24 or other imaging device. The vehicle 10 is controlled with autonomous vehicle controller 12 via communication link antenna 16. Articulating legs 18 adjust up and down with joint actuators 20 to maintain the platform 12 in level state or at a defined angle despite surface conditions encountered as the vehicle 10 moves with wheel actuators 22. The autonomous vehicle controller 12 communicates with joint actuators 20 and wheel actuators 22 via CAN bus or other communication protocols.

By actively controlling the roll and pitch of the vehicle chassis, the wheels of the vehicle may be allowed to go through holes and bumps, and up or down a curb, while still maintaining the payload camera in a steady even state or orientation. Existing remote camera platforms, without leveling technology typically operate on a rail or path that is smooth in order to provide an even ride for the camera payload. However, platforms limited to rails or paths will often result in limitations for the artistic input, since the vehicle platform will be limited to a subset of the terrain that is served by the rail or path. With embodiments of the self-leveling vehicle, many of these limitations are eliminated.

The roll, pitch, and heading for the vehicle 10 are measured with the 3D accelerometer, and 3D compass (3D magnetic sensors), configured as a tilt-compensated (TC) compass. A tilt compensated Compass is a device that can measure an object's horizontal orientation (i.e., direction within Earth's magnetic field) for any arbitrary orientation of that object in the vertical field (i.e., roll and pitch). In other words, for any forward or sideways rotation, a TC device will calculate the heading relative to the North Pole (An in-depth discussion on acquiring roll and pitch angles relative to gravity, and heading angle relative to earth magnetics' field, see [AN3192 by STMicroelectronics]. In instances where the reference frame of the RF position tracking system is orientated with a known orientation in the global coordinate system, then the heading from the TC compass can be related to the orientation within the RF reference frame. In general, the RF position tracking system may not be related to the global coordinate system, but to an ad-hoc system of locating base stations, and a calibration procedure takes place to correlate the TC compass measurement to the orientation within the reference frame of the RF positioning system.

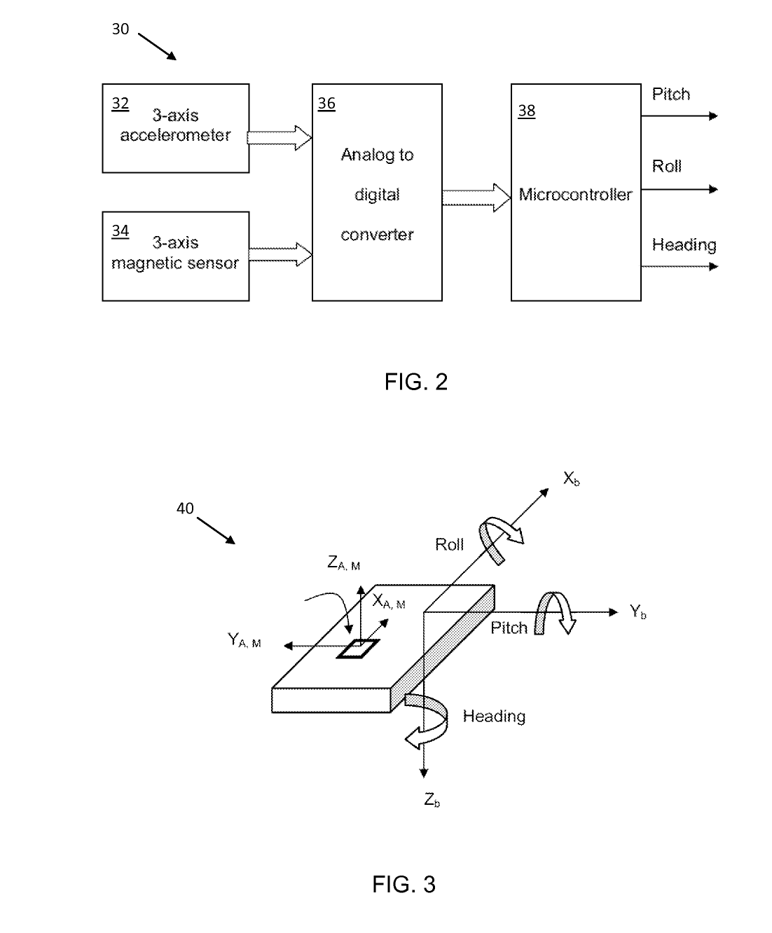

FIG. 2 is a schematic diagram of the electronic components that form a tilt-compensated (TC) compass 30 for use with the vehicle 10. The TC compass 30 operates by taking the output (analog) readings of a 3-axis accelerometer 32 and the output (analog) readings of a 3-axis magnetic sensor 34 and applying the readings to an analog to digital (A/D) converter 36, which then provides a digital data stream to a microcontroller 38 configured with software to calculate parameters including pitch, roll, and heading.

FIG. 3 is a schematic representation of a location measurement device 40 illustrating roll, pitch and yaw measurement determined from the TC compass 30 in Cartesian coordinates. TC compass 30 may be implemented as an integrated circuit (IC) such as an LSM303DLH available from STMicroelectronics.

The orientation information of the location measurement device 40 can now be used to enhance the accuracy of the RF position tracking system of the vehicle controller 14, depending on the operating scenario. With the knowledge of the current orientation and position, and with knowledge of the beacon locations for tracking, the system will be able to determine the direction of each of the range measurements to each of the beacons, and add a level of confidence to each of the measurements, depending on the reasonable estimation of the relative location of the vehicle 10. In an embodiment the base stations or beacons may be part of a mobile network. In an embodiment the base stations or beacons are formed in an ad hoc network communicating via high frequency ultra-wide bandwidth (UWB) wireless signals.

The foregoing description is illustrative of particular embodiments of the invention, but is not meant to be a limitation upon the practice thereof. The following claims, including all equivalents thereof, are intended to define the scope of the invention.

1. An autonomous self-leveling vehicle, said vehicle comprising:
a controller;
a RF antenna;
a platform attached to a plurality of articulating legs with joint actuators for leveling or maintaining said platform at a defined angle; and
a set of wheels powered by wheel actuators mounted to the distal ends of said plurality of articulating legs.

2. The vehicle of claim 1 wherein said controller further comprises a tracking module in electrical communication with said RF antenna and a tilt-compensated (TC) compass; and
wherein said TC compass provides data to calculate a translation of the position of said vehicle and said platform.

3. The vehicle of claim 2 wherein said tracking module comprises at least one of a 3D accelerometer, a 3D compass, a 3D Gyroscopic sensor, a rechargeable battery, and a microcontroller with software.

4. The vehicle of claim 1 wherein said controller is in electrical communication with said joint actuators and said wheel actuators via a controller area network (CAN).

5. The vehicle of claim 1 further comprising a camera mounted to said platform.

6. A system for a self-leveling vehicle, said system comprising:
at least three or more base stations;
a vehicle with a platform, said platform attached to a plurality of articulating legs with joint actuators for leveling or maintaining said platform at a defined angle;
a set of wheels powered by wheel actuators mounted to the distal ends of said plurality of articulating legs;
a RF antenna mounted to said vehicle; and
a controller with a tracking module.

7. The system of claim 6 wherein said tracking module communicates via said RF antenna with said at least three or more base stations to determine a location of said vehicle.

8. The system of claim 6 wherein said at least three or more base stations are formed in an ad hoc network communicating via high frequency ultra-wide bandwidth (UWB) wireless signals.

9. The system of claim 6 wherein said at least three or more base stations form a mobile network.

10. The system of claim 6 wherein said tracking module further comprises a tilt-compensated (TC) compass; and
wherein said TC compass provides data to calculate a translation of the position of said vehicle and said platform.

11. The system of claim 6 wherein said tracking module further comprises at least one of a 3D accelerometer, a 3D compass, a 3D Gyroscopic sensor, a rechargeable battery, and a microcontroller with software.

12. The system of claim 6 wherein said controller is in electrical communication with said joint actuators and said wheel actuators via a controller area network (CAN).

13. The system of claim 6 further comprising a camera mounted to said platform.
